(19) United States
(12) Patent Application Publication
(10) Pub. No.: US 2003/0006115 A1
(43) Pub. Date: Jan. 9, 2003

(54) Reverse gear transmission device of differential of vehicle

(76) Inventor: Tai-Yang Luh, Taipen (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/900,996

(22) Filed: Jul. 9, 2001

(51) Int. Cl. F16H 48/16; F16D 47/04

(52) U.S. Cl. 192/48.6; 192/50; 74/650

(57) ABSTRACT

The present invention relates to a reverse gear transmission device of a differential of a vehicle. The vehicle is provided with a drive shaft provided with differentials each containing an one-way thrust bearing therein. The gear shift stick of the vehicle is provided with a linking member. When the gear shift stick is moved to a reverse gear position, the linking member may be driven by a mechanic linking lever or a motorized magnet so as to move an operation member which may drive and move the clutch into the differential, so that the one-way thrust bearing may still combine with the drive shaft to transmit the power even when the vehicle is reversed.

### BACKGROUND OF THE INVENTION

1. Field of the Invention

The present invention relates to a reverse gear transmission device of a differential of a vehicle.

2. Description of the Related Art

Usually, the vehicle may use the one-way thrust bearing to function as a differential. The thrust direction of the one-way thrust bearing is the same as that of the travel of the vehicle, while the idle direction of the one-way thrust bearing is the same as that of the reverse of the vehicle. When the vehicle turns around, the turning radius of the inner-side wheel is shorter than that of the outer-side wheel. The one-way thrust bearing of the inner-side differential will adapted to balance the velocity difference between the inner-side wheel and the outer-side wheel. However, when the vehicle is reversed, the one-way thrust bearing cannot be rotated in concert with the drive shaft, so that the vehicle may move forward and cannot move backward.

### SUMMARY OF THE INVENTION

The primary objective of the present invention is to provide a reverse gear transmission device of a differential of a vehicle, wherein the drive shaft is provided with outer splines for mounting a clutch, so that inner splines of the clutch may slide on the outer splines of the drive shaft, and the differential and the clutch are respectively provided with mating locking blocks and locking grooves. The linking member may drive an operation member to move the clutch into the differential, so that the one-way thrust bearing of the differential may still combine with the drive shaft even when the vehicle is reversed.

In accordance with the present invention, there is provided a reverse gear transmission device of a differential of a vehicle, the vehicle provided with a drive shaft provided with at least one differential containing an one-way thrust bearing therein, wherein:

the drive shaft is provided with outer splines for mounting a clutch, so that inner splines of the clutch may slide on the outer splines of the drive shaft, the differential and the clutch are respectively provided with mating locking blocks and locking grooves, when a gear shift stick is moved to a reverse gear position, a linking member may be driven by a mechanic linking lever or a motorized magnet so as to move an operation member, the operation member has one end received in an annular groove of the clutch, so that the mating locking blocks and locking grooves of the differential and the clutch may be combined with each other respectively, and so that the one-way thrust bearing and the drive shaft may be rotated reversely at a neutral status.

The thrust direction of the one-way thrust bearing is the same as that of the travel of the vehicle. When the vehicle is reversed, the one-way thrust bearing cannot be rotated in concert with the drive shaft, so that the drive shaft has to be provided with outer splines for mounting a clutch, so that inner splines of the clutch may slide on the outer splines of the drive shaft. At the same time, the differential and the clutch are respectively provided with mating locking blocks and locking grooves. When the gear shift stick is moved to the reverse gear position, the linking member may be driven by the mechanic linking lever or the motorized magnet so as to move the operation member. The operation member has one end received in the annular groove of the clutch, so that the mating locking blocks and locking grooves of the differential and the clutch may be combined with each other respectively, and so that the one-way thrust bearing and the drive shaft may be rotated reversely at the neutral status.

Further benefits and advantages of the present invention will become apparent after a careful reading of the detailed description with appropriate reference to the accompanying drawings.

### BRIEF DESCRIPTION OF THE DRAWINGS

FIG. 1 is a schematic plan view of the usage status of a reverse gear transmission device of a differential of a vehicle in accordance with the present invention;

FIG. 2 is an exploded perspective view of a reverse gear transmission device of a differential of a vehicle in accordance with the present invention;

FIG. 3 is a front plan cross-sectional assembly view of the reverse gear transmission device of a differential of a vehicle as shown in FIG. 2;

FIG. 4 is a schematic plan view of a forward gear status of the reverse gear transmission device of a differential of a vehicle as shown in FIG. 1;

FIG. 4A is a cross-sectional view of the reverse gear transmission device of a differential of a vehicle as shown in FIG. 4;

FIG. 5 is a schematic plan view of a reverse gear status of the reverse gear transmission device of a differential of a vehicle as shown in FIG. 1;

FIG. 5A is a cross-sectional view of the reverse gear transmission device of a differential of a vehicle as shown in FIG. 5;

FIG. 6 is a schematic plan view of the touching status of the reverse gear transmission device of a differential of a vehicle in accordance with the present invention; and

FIG. 7 is a schematic plan view of the fixing status of the reverse gear transmission device of a differential of a vehicle in accordance with the present invention.

### DETAILED DESCRIPTION OF THE INVENTION

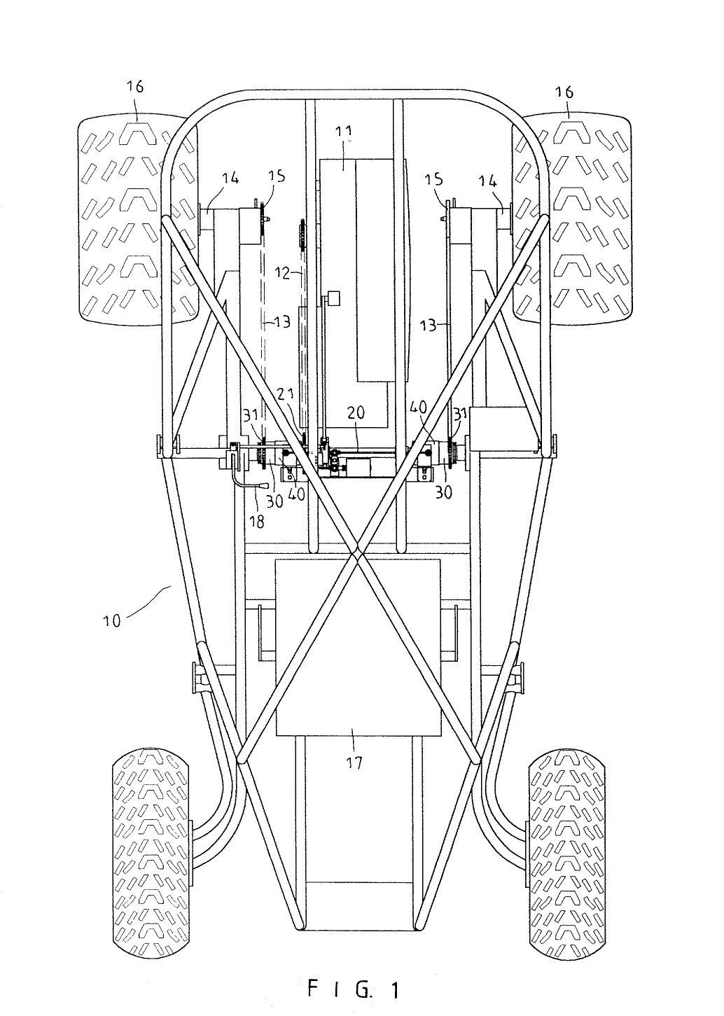

Referring to the drawings and initially to FIG. 1, the usage status of a reverse gear transmission device of a differential of a vehicle in accordance with the present invention is shown. The vehicle 10 has an engine 11 whose power is transmitted to the drive gear 21 of a drive shaft 20 by a chain 12. The drive shaft 20 has two sides each provided with a differential 30 whose outer portion is provided with a differential gear 31 which may transmit the power of the engine 11 to the drive gear 15 of a rear wheel axle 14 by a chain 13, so as to drive the rear wheel 16 of the vehicle 10. A gear shift stick 18 is provided beside the driver seat 17, so that the vehicle 10 may be moved forward and backward. Each of the two sides of the drive shaft 20 is provided with a clutch 40 located adjacent to the differential 30. When the vehicle 10 is reversed, the clutch 40 co-operates with the differential 30, so that the power of the engine 11 may be transmitted to the differential gear 31 of the differential 30 through the clutch 40 of the drive shaft 20.

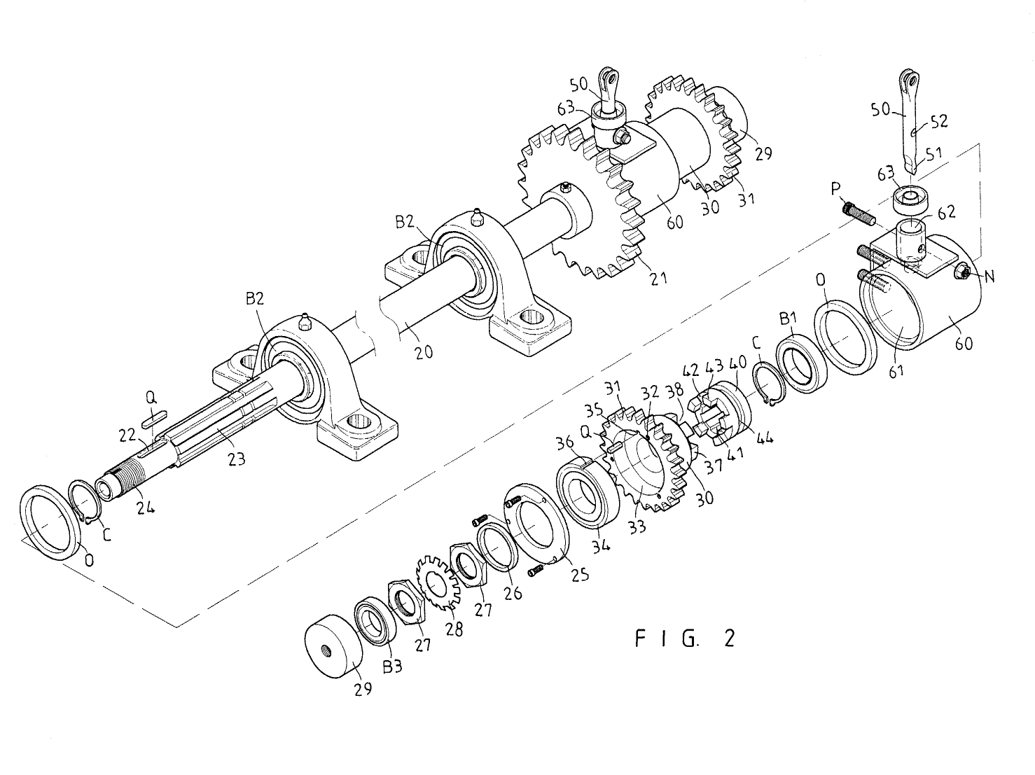

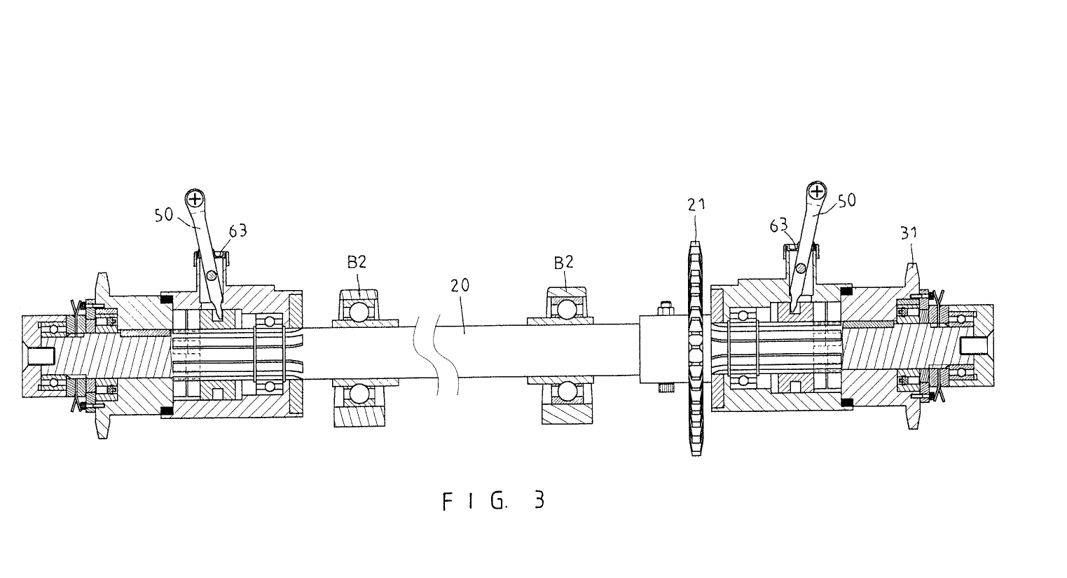

Referring to FIGS. 2 and 3, the differential 30 is provided with a central shaft hole 32 and a shaft hole seat 33. An one-way thrust bearing 34 is mounted in the shaft hole seat 33. The central shaft hole 32 and the shaft hole seat 33 of the differential 30 are provided with keyways 35, whereby the keys “Q” may be secured in the keyways 35, and may be secured in the keyway 22 of the drive shaft 20, and the keyway 36 of the thrust bearing 34, so that the drive shaft 20, the thrust bearing 34, and the differential 30 may be integrally combined with each other. thus, the drive shaft 20 is subjected to the thrust action of the thrust bearing 34, to produce a differential function. The differential 30 has one end opposite to the thrust bearing 34 provided with locking blocks 37 and locking grooves 39 for combining the differential 30 with the clutch 40.

The clutch 40 has an inner portion provided with inner splines 41 that may be slidably combined with the outer splines 23 of the drive shaft 20. The clutch 40 has an outer portion provided with locking grooves 42 and locking blocks 43 that may be integrally combined with the locking blocks 37 and the locking grooves 39 of the differential 30, so that the clutch 40 may be combined with the differential 30. The outer portion of the clutch 40 has a middle formed with an annular groove 44, so that the drive portion 51 of an operation member 50 may be received in the annular groove 44, for moving the clutch 40.

A seat body 60 has an axial through hole 61 for receiving the clutch 40, and a radial through hole 62 for receiving the operation member 50. A bearing “B1” is sealed and secured in the axial through hole 61 by oil seals “O” and C-shaped snap rings “C”. The operation member 50 has a middle formed with a pivot hole 52, so that the operation member 50 may be pivoted in the radial through hole 62 by a screw “P” and a nut “N”. a dustproof cover 63 is mounted on the outer portion of the radial through hole 62. The operation member 50 has an upper end pivoted to a linking member 70.

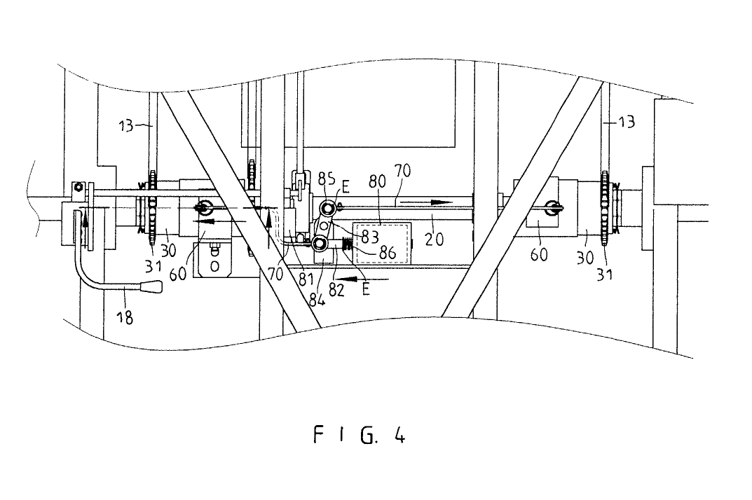

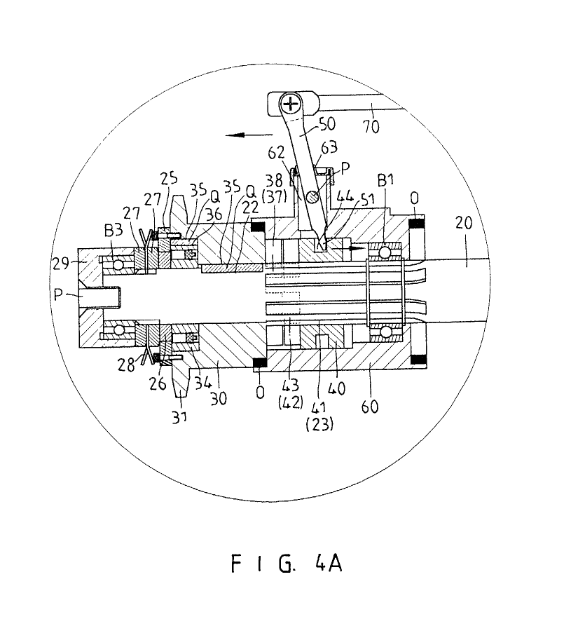

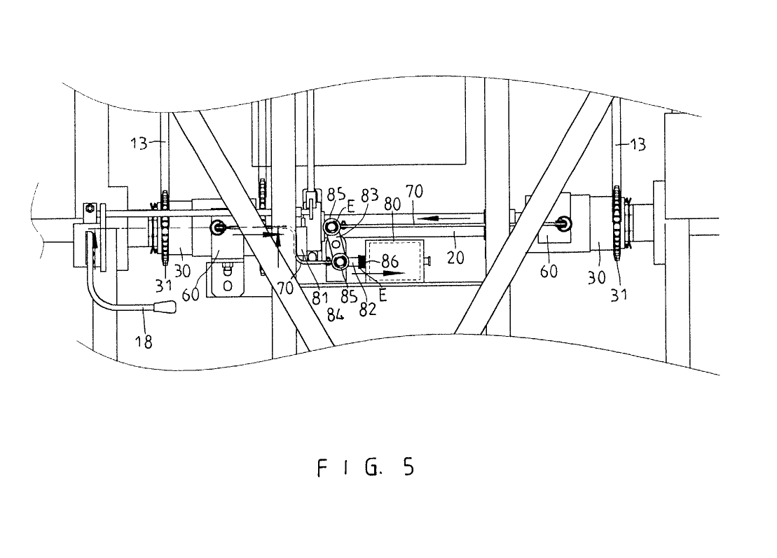

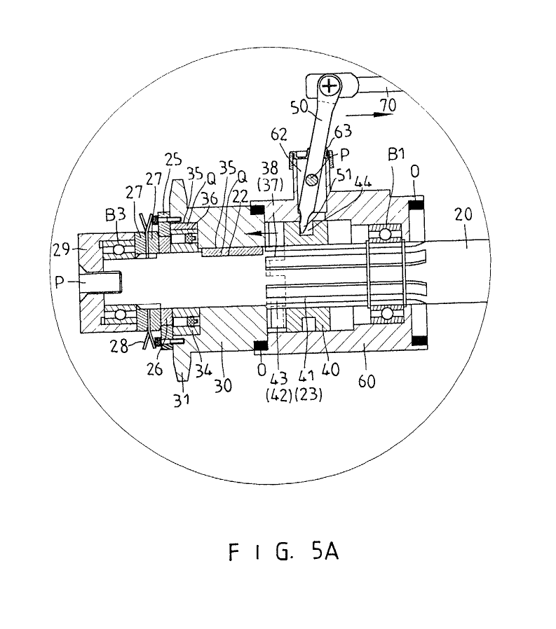

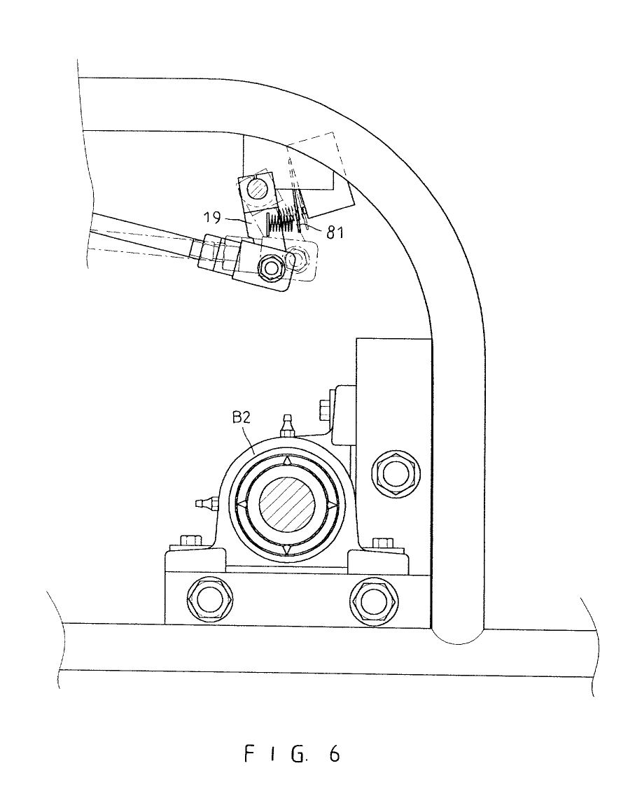

FIGS. 4 and 4A show the forward gear status of the present invention, and FIGS. 5 and SA show the reverse gear status of the present invention. When the vehicle 10 shifts gear, the linking member 70 may be driven by a mechanic linking lever or a motorized magnet. As shown in the figures, the linking member 70 may be driven by a motorized magnet 80. When the gear shift stick 18 is moved to the reverse gear position, the driving member 19 of the gear shift stick 18 will touch the microswitch 81 as shown in FIG. 6, thereby in turn actuating the motorized magnet 80 to produce a magnetically exciting effect, so as to move the magnetic shaft 82 of the motorized magnet 80, thereby pulling the rotation member 83. The center of the rotation member 83 has two ends pivoted with driven members 85 by pins “Q” and E-shaped snap rings “E”. the driven member 85 has one end pivoted with the linking member 70. An elastic restoring member 86 is secured on the magnetic shaft 82 by the E-shaped snap ring “E”, such that when the motorized magnet 80 does not produce the magnetically exciting effect, the magnetic shaft 82 may be returned its original position by the elastic force of the elastic restoring member 86, and so that the clutch 40 is placed at the neutral position.

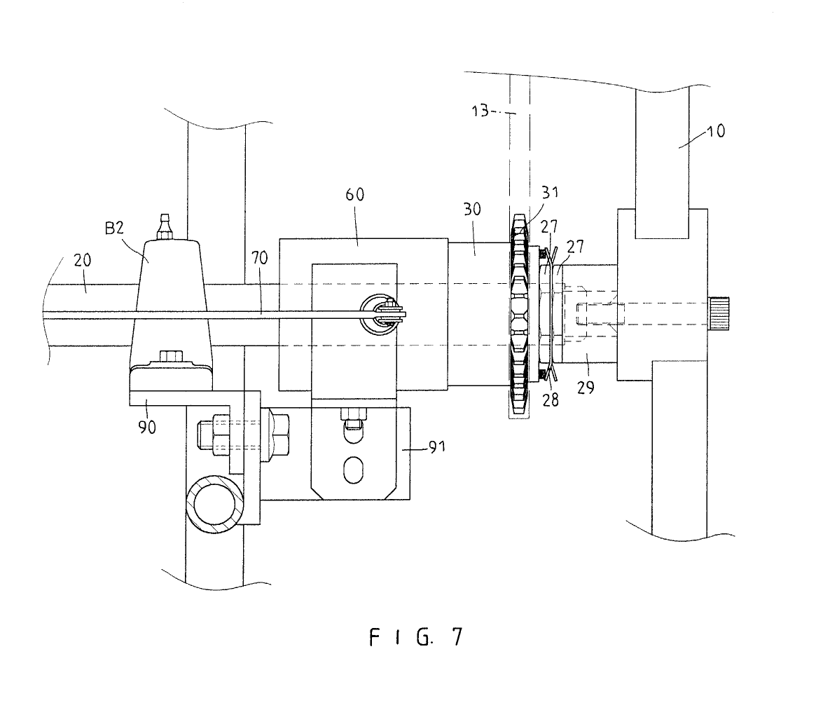

Referring to FIGS. 2 and 7, for preventing the drive shaft 20 from being bent due to the excessive length, the middle of the drive shaft 20 is provided with two bearings “B2”. The drive shaft 20 has two outer ends each provided with an outer thread section 24. The drive shaft 20 may be serially provided with a bearing cap 25, a washer 26, a nut 27, a retaining washer 28, a nut 27, a bearing “B3”, and a bearing seat 29, and the bearing seat 29 is locked and fixed on the vehicle 10 by a screw “P”. The vehicle 10 may be additionally provided with a vertical fixing plate 90 and a horizontal fixing plate 91, for locking and fixing the bearing “B2” and the seat body 60 which contains the clutch 40.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A reverse gear transmission device of a differential of a vehicle, said vehicle provided with a drive shaft provided with at least one differential containing an one-way thrust bearing therein, wherein:
said drive shaft is provided with outer splines for mounting a clutch, so that inner splines of said clutch may slide on said outer splines of said drive shaft, said differential and said clutch are respectively provided with mating locking blocks and locking grooves, when a gear shift stick is moved to a reverse gear position, a linking member may be driven by a mechanic linking lever or a motorized magnet so as to move an operation member, said operation member has one end received in an annular groove of said clutch, so that said mating locking blocks and locking grooves of said differential and said clutch may be combined with each other respectively, and so that said one-way thrust bearing and said drive shaft may be rotated reversely at a neutral status.
